(19) United States
(12) Patent Application Publication
(10) Pub. No.: US 2010/0095679 A1
(43) Pub. Date: Apr. 22, 2010

(54) DUAL WALL STRUCTURE FOR USE IN A COMBUSTOR OF A GAS TURBINE ENGINE

(75) Inventors: Nagaraja S. Rudrapatna, Chandler, AZ (US); David Waldman, Chandler, AZ (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/256,226

(22) Filed: Oct. 22, 2008

(51) Int. Cl. F23R 3/44; F02C 7/12

(52) U.S. Cl. 60/752; 415/116

(57) ABSTRACT

A dual wall structure for a combustor of a gas turbine engine including an inner liner and an outer liner coupled to a combustor dome and defining a combustion chamber there between. Each of the inner liner and the outer liner include an outer wall and an inner wall. Each of the outer walls includes a plurality of impingement holes formed therein for allowing a coolant to flow therethrough. Each of the inner walls is coupled to the outer wall via a plurality of threaded studs and includes a plurality of forward heat shield panels and a plurality of aft heat shield panels. Each of the plurality of forward heat shield panels and aft heat shield panels includes a plurality of side rails, a forward rail, and an aft rail including a plurality of controlled openings, that when coupled to the outer wall defines a single cavity there between. A plurality of cavities being formed by the plurality of forward and aft heat shield panels.

### TECHNICAL FIELD

The present invention relates to gas turbine engine combustors and, more particularly, to a wall structure for a gas turbine engine combustor.

### BACKGROUND

A gas turbine engine may be used to power various types of vehicles and systems. A particular type of gas turbine engine that may be used to power aircraft is a turbofan gas turbine engine. A turbofan gas turbine engine may include, for example, five major sections, a fan section, a compressor section, a combustor section, a turbine section, and an exhaust section. The fan section is positioned at the front, or “inlet” section of the engine, and includes a fan that induces air from the surrounding environment into the engine, and accelerates a fraction of this air toward the compressor section. The remaining fraction of air induced into the fan section is accelerated into and through a bypass plenum, and out the exhaust section.

The compressor section raises the pressure of the air it receives from the fan section to a relatively high level. The compressed air from the compressor section then enters the combustor section, where a ring of fuel nozzles injects a steady stream of fuel into a combustor. The injected fuel is ignited by a burner, which significantly increases the energy of the compressed air.

The high-energy compressed air from the combustor section then flows into and through the turbine section, causing rotationally mounted turbine blades to rotate and generate energy. The air exiting the turbine section is exhausted from the engine via the exhaust section, and the energy remaining in this exhaust air aids the thrust generated by the air flowing through the bypass plenum.

The exhaust air exiting the engine may include varying levels of one or more pollutants. For example, the exhaust air may include, at varying levels, certain oxides of nitrogen (NOₓ), carbon monoxide (CO), unburned hydrocarbons (UHC), and smoke. In recent years, environmental concerns have placed an increased emphasis on reducing these, and other, exhaust gas emissions from gas turbine engines. In some instances, emission-based landing fees are imposed on aircraft that do not meet certain emission standards. As a result, engine ownership and operational costs can increase. One means of addressing the emission issue is by reduction of the unwanted emissions from within the combustor section. During operation, the combustion process that takes place in the combustor section results in the combustor walls being exposed to extremely high temperatures. In order to reduce unwanted emissions, more air is needed for cooling within the combustor section. Typically, the amount of air coming from the compressor section of a gas turbine engine is fixed for a given thermodynamic cycle. This means that there is less air available for cooling of the combustor walls. The reduction in cooling air for the combustor typically results in higher metal temperatures. Furthermore, combustors with single wall annular construction suffer from hoop stress effects. The high metal temperature due to less cooling air coupled with high hoop stress due to monolithic construction of combustors results in premature failures and reduced durability.

Accordingly, there is a need for a superior combustor design that incorporates improved mechanical arrangement and efficient cooling techniques. In addition, there is a need for a gas turbine engine that can operate with reduced levels of exhaust gas emissions and/or that can reduce the likelihood of an owner being charged an emission-based landing fee and/or can reduce ownership and operational costs.

### BRIEF SUMMARY

The present invention provides a dual wall structure for a combustor of a gas turbine engine and a combustor for a gas turbine engine that includes the dual wall structure.

In one embodiment, and by way of example only, there is provided a dual wall structure for a combustor of a gas turbine engine comprising: a combustor dome; an outer liner coupled to said combustor dome; and an inner liner coupled to said combustor dome and spaced a distance from said outer liner. Each of said outer liner and said inner liner comprise: an outer wall; and an inner wall coupled to the outer wall and separated from the outer wall by a finite distance. The inner wall comprising a plurality of forward heat shield panels, each having a hot side and a cold side, the cold side including a plurality of side rails, a forward rail and an aft rail that when coupled to the outer wall define a cavity there between. A plurality of cavities are formed by the plurality of forward heat shield panels. The inner wall further comprising a plurality of aft heat shield panels, each having a hot side and a cold side, the cold side including a plurality of side rails, a forward rail and an aft rail that when coupled to the outer wall define a cavity there between. A plurality of cavities are formed by the plurality of aft heat shield panels. Each of said outer liner and said inner liner further comprising a plurality of threaded studs extending substantially perpendicular from a surface of the cold side of each of the plurality of forward heat shield panels and the plurality of aft heat shield panels. Each of the plurality of threaded studs comprising a threaded cylindrical component coupled to a platform. The aft rail of each of the plurality of forward heat shield panels and the plurality of aft heat shield panels includes a plurality of controlled openings formed therein providing fluidic communication between each of the plurality of cavities and the surface of the hot sides of each of the plurality of forward heat shield panels and the plurality of aft heat shield panels. The longitudinal length of the combustor is spanned by a single forward heat shield panel of the plurality of forward heat shield panels and by a single aft heat shield panel of the plurality of aft heat shield panels. Each of the plurality of forward heat shield panels and the plurality of aft heat shield panels includes a plurality of effusion holes for allowing the coolant to flow from the cold side to the hot side and form a cooling film on the surface of the hot side.

In another exemplary embodiment, and by way of example only, there is provided a dual wall structure for a combustor of a gas turbine engine including a combustor dome; an outer liner coupled to said combustor dome; and an inner liner coupled to said combustor dome and spaced a distance from said outer liner. Each of said outer liner and said inner liner comprise an outer wall including a plurality of impingement holes formed therein for allowing a coolant to flow therethrough; and an inner wall coupled to the outer wall. The inner wall comprising a plurality of forward heat shield panels and a plurality of aft heat shield panels, each having a hot side and a cold side. Each of the plurality of forward heat shield panels and the plurality of aft heat shield panels further comprising a plurality of side rails, a forward rail, and an aft rail extending substantially perpendicular from a surface of the cold side, the plurality of side rails, the forward rail and the aft rail defining a cavity between the inner wall and the outer wall when coupled together. A plurality of cavities are formed by the plurality of forward heat shield panels and said plurality of aft heat shield panels. Each of the plurality of forward heat shield panels and the plurality of aft heat shield panels further comprising a plurality of threaded studs extending substantially perpendicular from the surface of the cold side and through a plurality of holes defined in the outer wall. Each of the plurality of threaded studs comprising a threaded cylindrical component coupled to a platform and providing a means for coupling each of the plurality of forward heat shield panels and the plurality of aft heat shield panels to the outer wall. The aft rail of each of the plurality of forward heat shield panels and the plurality of aft heat shield panels includes a plurality of controlled openings formed therein, the plurality of controlled openings providing fluidic communication between each of the plurality of cavities and the surface of the hot side of each of the plurality of forward heat shield panels and the plurality of aft heat shield panels. A longitudinal length of the combustor is spanned by a single forward heat shield panel of the plurality of forward heat shield panels and by a single aft heat shield panel of the plurality of aft heat shield panels.

In yet another exemplary embodiment, and by way of example only, there is provided a combustor for a gas turbine engine including an outer liner and an inner liner coupled to a combustor dome, wherein the inner liner and the outer liner define a combustion chamber there between. An outer wall comprises a portion of each of the outer liner and the inner liner. A plurality of forward heat shield panels and a plurality of aft heat shield panels comprise a portion of each the outer liner and the inner liner. A plurality of threaded studs extend substantially perpendicular from a surface of each of the plurality of forward heat shield panels and the plurality of aft heat shield panels. Each of the plurality of threaded studs comprising a threaded cylindrical component coupled to a platform with brazing. Each of the plurality of forward heat shield panels and the plurality of aft heat shield panels has a hot side and a cold side; the cold side having a plurality of side rails, a forward rail and an aft rail that when coupled to the outer wall of each of the outer liner and the inner liner define a cavity between each of the plurality of forward heat shield panels and the plurality of aft heat shield panels and the outer wall. A plurality of cavities formed by the plurality of forward heat shield panels and the plurality of aft heat shield panels. The plurality of forward heat shield panels and the plurality of aft heat shield panels are coupled to the outer wall in a circumferentially aligned configuration and form a plurality of aligned gaps between each of the plurality of forward heat shield panels and the plurality of aft heat shield panels. Each of the plurality of forward heat shield panels and the plurality of aft heat shield panels includes a plurality of effusion holes for allowing a coolant to flow from the cold side to the hot side and form a cooling film on a surface of the hot side.

Other independent features and advantages of the dual wall structure for a combustor of a gas turbine engine and a combustor for a gas turbine engine incorporating the dual wall structure will become apparent from the following detailed description, taken in conjunction with the accompanying drawings which illustrate, by way of example, the principles of the invention.

### BRIEF DESCRIPTION OF THE DRAWINGS

The present invention will hereinafter be described in conjunction with the following drawing figure, wherein:

FIG. 1 is a simplified, cross-sectional view of a gas turbine engine, according to an embodiment

FIG. 2 is a partial, cross-sectional view of the combustor section of FIG. 1 including a dual wall structure according to an embodiment;

FIG. 3 is a three-dimensional exploded view of a portion of the dual wall structure combustor according to an embodiment;

FIG. 4 is a three-dimensional view of a portion of the dual wall structure combustor according to an embodiment;

FIG. 5 is a three-dimensional view of a portion of a forward heat shield panel and an aft heat shield panel according to an embodiment;

FIG. 6 is an enlarged sectional view of a threaded stud according to an embodiment; and

FIG. 7 is a three-dimensional plan view of a portion of the dual wall structure combustor of FIG. 2 according to an embodiment.

### DETAILED DESCRIPTION

Before proceeding with the description, it is to be appreciated that the following detailed description is merely exemplary in nature and is not intended to limit the invention or the application and uses of the invention. Furthermore, there is no intention to be bound by any theory presented in the preceding background or the following detailed description.

The embodiment disclosed herein is described in sufficient detail to enable those skilled in the art to practice the invention, and it is to be understood that other embodiments may be utilized and that logical mechanical changes may be made without departing from the scope of the present invention. Furthermore, it will be understood by one of skilled in the art that although the specific embodiment illustrated below is directed at a combustor of a gas turbine engine in an aircraft, for purposes of explanation, the apparatus may be used in various other embodiments employing combustors typically found in gas turbine engines. The following detailed description is, therefore, not to be taken in a limiting sense.

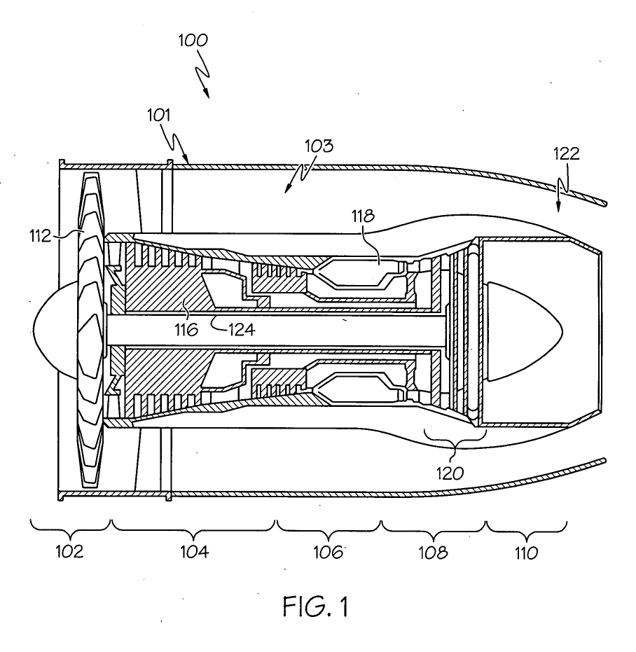

FIG. 1 is a simplified, cross-sectional view of a gas turbine engine 100, according to an embodiment. The engine 100 may be disposed in an engine case 101 and may include a fan section 102, a compressor section 104, a combustion section 106, a turbine section 108, and an exhaust section 110. The fan section 102 may include a fan 112, which draws air into the fan section 102 and accelerates it. A fraction of the accelerated air exhausted from the fan 112 is directed through a bypass section 103 to provide a forward thrust. The remaining fraction of air exhausted from the fan 112 is directed into the compressor section 104.

The compressor section 104 may include a series of compressors 116, which raise the pressure of the air directed into it from the fan 112. The compressors 116 may direct the compressed air into the combustion section 106. In the combustion section 106, which includes an annular combustor 118, the high pressure air is mixed with fuel and combusted. The combusted air is then directed into the turbine section 108.

The turbine section 108 may include a series of turbines 120, which may be disposed in axial flow series. The combusted air from the combustion section 106 expands through the turbines 120, causing them to rotate. The air is then exhausted through a propulsion nozzle 122 disposed in the exhaust section 110, providing additional forward thrust. In an embodiment, the turbines 120 rotate to thereby drive equipment in the engine 100 via concentrically disposed shafts or spools. Specifically, the turbines 120 may drive the compressor 116 via one or more rotors 124.

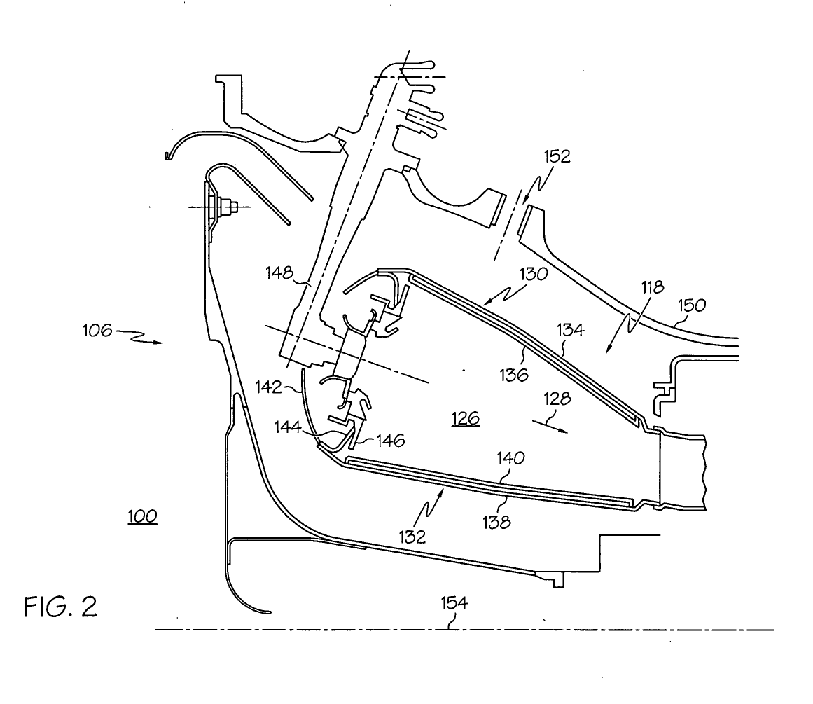

Turning now to FIG. 2, illustrated is a portion of the gas turbine engine 100, and more particularly a portion of the combustion section 106 including the annular combustor 118. The annular combustor 118 is conventionally configured with an outer liner 130 and an inner liner 132, defining a combustion chamber 126 there between. The combustor airflow through the combustion chamber 126 is designated by a directional arrow 128. Each of the outer liner 130 and the inner liner 132 are defined by an outer wall and an inner wall. More specifically, the outer liner 130 is comprised of an outer wall 134 and an inner wall 136. The inner liner 132 is comprised of an outer wall 138 and an inner wall 140. The combustion section 106 further includes a dome shroud 142, a dome 144 and a dome heat shield 146. A fuel nozzle 148 is coupled to a combustor case 150, which further includes an igniter hole 152 formed therein. In FIG. 2, only half the structure is shown, it being substantially rotationally symmetric about a centerline and axis of rotation 154.

In a preferred embodiment, each of the outer walls 134 and 138 of the outer liner 130 and inner liner 132, respectively, are formed of a continuous sheet of material, such as a metal. Each of the inner walls 136 and 140 of the outer liner 130 and the inner liner 132 are comprised of a plurality of heat shield panels that provide heat shielding of the outer walls 134 and 138.

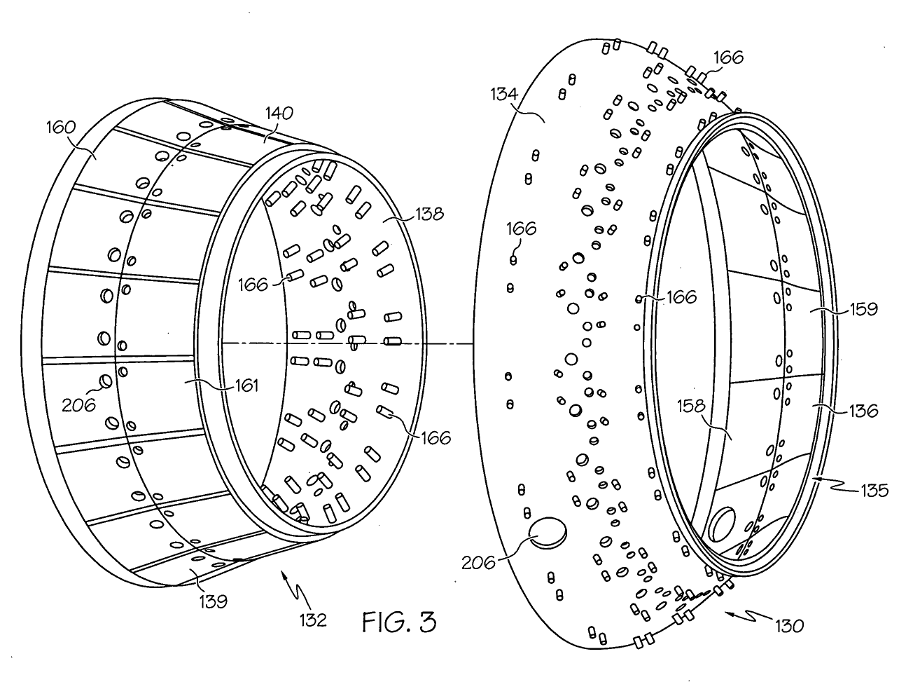

Referring now to FIG. 3, illustrated is a three-dimensional exploded view of the outer liner 130 and the inner liner 132. More specifically, illustrated is the outer liner 130 comprised of the outer wall 134 and the inner wall 136 and the inner liner 132 comprised of the outer wall 138 and the inner wall 140. In a preferred embodiment, the inner wall 136 is comprised of a plurality of discrete forward heat shield panels 158 and a plurality of discrete aft heat shield panels 159, each being cast as a single piece of material, that essentially line a hot side 135 of the outer wall 134 of the outer liner 130. In an alternative embodiment, the plurality of discrete heat shield panels may be machined out of a plate metal, a bar stock of metal, or the like. Similarly, the inner wall 140 is comprised of a plurality of discrete forward heat shield panels 160 and a plurality of discrete aft heat shield panels 161 that essentially line a hot side 139 of the outer wall 138 of the inner liner 132. Each of the pluralities of forward and aft heat shield panels 158, 159, 160 and 161 are bolted to their respective outer wall 134, 138 via a plurality of threaded studs 166 (described presently), being secured with a washer 173 and a nut 175, or similar securement means.

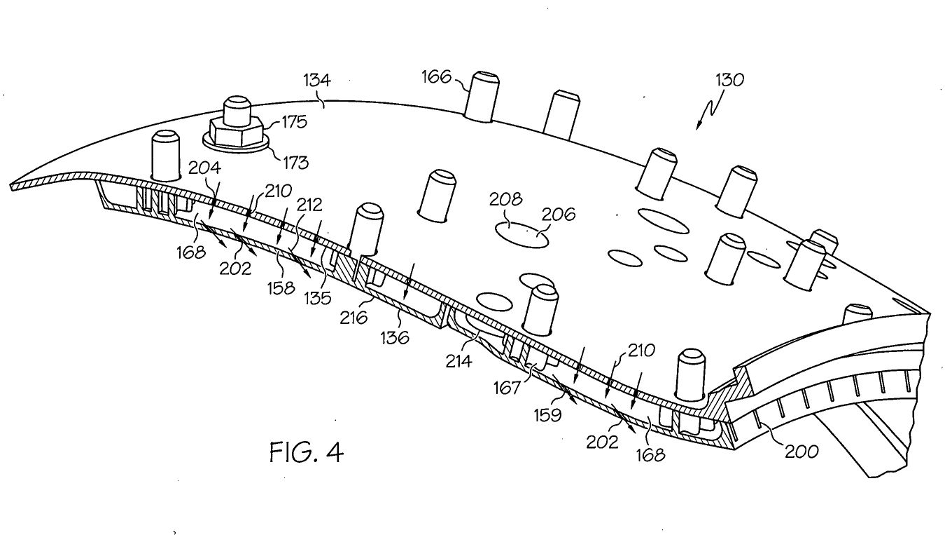

Referring now to FIG. 4, illustrated in a three-dimensional partial sectional view is a portion of the outer liner 130. As best illustrated by the forward heat shield panel 158 and the aft heat shield panel 159, each of the plurality of forward heat shield panels 158, 160 and aft heat shield panels 159, 161 extends substantially one-half the overall longitudinal length of the combustion chamber 126 and defines a cavity 168 between each of the forward heat shield panels 158, each of the aft heat shield panels 159 and the outer wall 134 to which each is coupled. It should be understood that while only the outer liner 130 is illustrated and described with respect to FIG. 4, the components of the outer liner 130 are representative of the components that comprise the inner liner 132.

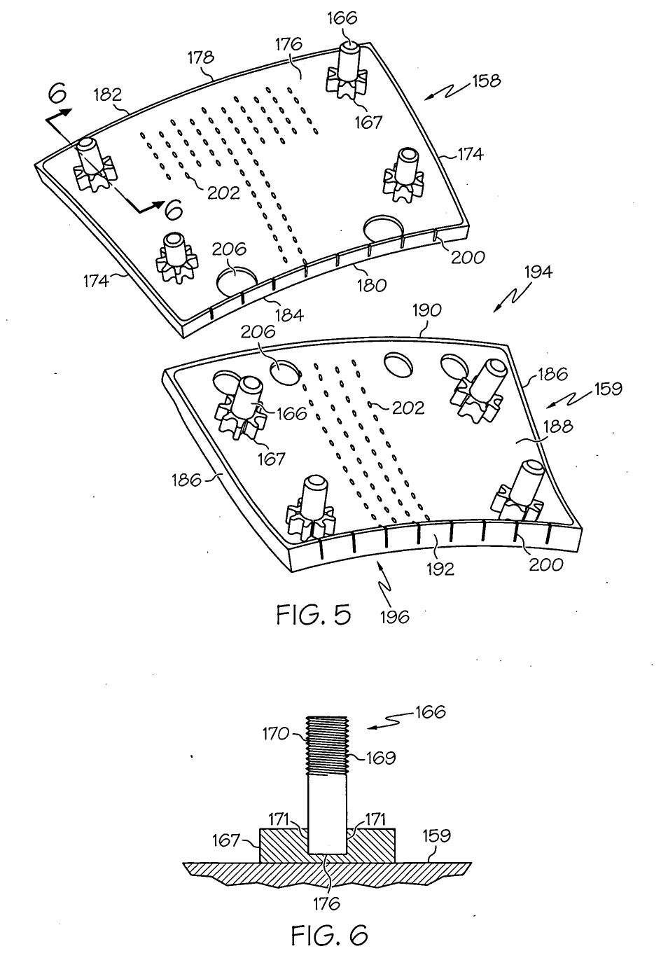

Referring now to FIG. 5, illustrated is a single forward heat shield panel 158 and a single aft heat shield panel 159. It should be understood that while only a single forward heat shield panel and a single aft heat shield panel are illustrated and described with respect to FIG. 4, the forward heat shield panel 158 is a representative example of the plurality of forward heat shield panels 158 and the aft heat shield panel 159 is a representative example of the plurality of aft heat shield panels 159 that comprise the inner walls 136 and 140 (FIG. 3). Each of the forward heat shield panels 158 and the aft heat shield panels 159 are formed as substantially curvilinear components, with a slight concave shape to allow for definition of the combustion chamber 126. Alternatively, each of the plurality of forward heat shield panels 160 and each of the plurality of aft heat shield panels 161 (FIG. 3) may have a slight convex shape to allow for definition of the combustion chamber. As previously stated, a single forward heat shield panel 158 and a single aft heat shield panel 159, in combination extend substantially the longitudinal length of the annular combustor 118 when properly positioned and coupled to the outer wall 134 (FIG. 4). A plurality of side rails 174 extend perpendicular to an interior surface 176 of the forward heat shield panel 158. In addition, a forward rail 178 and an aft rail 180 extend perpendicular to the interior surface 176 at a forward end 182 and an aft end 184, respectively, of the forward heat shield panel 158. In combination, the side rails 174, the forward rail 178 and the aft rail 180 form a rail about four perimeter sides or edges of the forward heat shield panel 158 and in define the cavity 168 (FIG. 4) between the outer wall 134 and the inner wall 136 (FIG. 4) when coupled together. Similarly, a plurality of side rails 186 extend perpendicular to an interior surface 188 of the aft heat shield panel 159. In addition, a forward rail 190 and an aft rail 192 extend perpendicular to the interior surface 188 at a forward end 194 and an aft end 196, respectively, of the aft heat shield panel 159. In combination, the side rails 186, the forward rail 190 and the aft rail 192 form a rail about the four perimeter sides or edges of the aft heat shield panel 159 and define the cavity 168 (FIG. 4) between the outer wall 134 and the inner wall 136 (FIG. 4) when coupled together.

When the forward heat shield panel 158 is coupled to the outer wall 134, the side rails 174, the forward rail 178 and the aft rail 180 are in sealing engagement with the outer wall 134. In addition, when the aft heat shield panel 159 is coupled to the outer wall 134, the side rails 186, the forward rail 190 and the aft rail 192 are similarly in sealing engagement with the outer wall 134. To provide for coupling, each of the plurality of forward heat shield panels 158 and the plurality of aft heat shield panels 159 includes the plurality of the threaded studs 166, of which in this preferred embodiment four (4) are illustrated per panel. In the illustrated embodiment, each of the threaded studs 166 is comprised of a threaded cylindrical component 169 that is coupled to a star-shaped platform 167 on the interior surface 176 of the forward heat shield panel 158 and on the interior surface 188 of the aft heat shield panel 159 to provide for increased surface area and additional heat transfer capabilities, as well as a provide a strong mechanical platform during coupling of the plurality of forward heat shield panels and the plurality of aft heat shield panels 159 to the outer wall 134. In an alternative embodiment, the threaded cylindrical component 169 is coupled to a platform having an overall geometry that lends itself to providing a strong mechanical support to the overall threaded stud 166.

The aft rails 180 and 192 are each configured to include a plurality of controlled openings 200 formed therein. In one preferred embodiment, the plurality of controlled openings 200 may be formed as slots in the aft rail 180 and 192. The plurality of controlled openings 200 provide a means for purging the cavities 168, and more particularly, provide a means for air to flow out of the cavities 168 and aid in the initiating and augmenting of a cooling air film 214 on the hot side of each of the inner walls 136 and 140 (FIG. 3). In alternate embodiment, the plurality of controlled openings 200 may be formed as substantially circular openings, or similar type configurations that would provide for the passage of a cooling air from within the cavities 168.

Referring now to FIG. 6, illustrated is an enlarged sectional view of one of the plurality of threaded studs 166, and more particularly a threaded cylindrical component 169 coupled to a star-shaped platform 167. In a preferred embodiment, the threaded cylindrical component 169 includes a plurality of threads 170 formed at one end thereof. The threaded cylindrical component 169 is coupled to the star-shaped platform 167 by brazing about a circumferential interface 171. In an alternate embodiment, the threaded cylindrical component 169 is coupled to the star-shaped platform 167 by tack-welding about a circumferential interface 171 or tap-fitting the cylindrical component 169 into a hole (not shown) in the star-shaped platform 167. In addition, to or in the alternative, the threaded cylindrical component 169 is coupled to the star-shaped platform 167 at an interface 172.

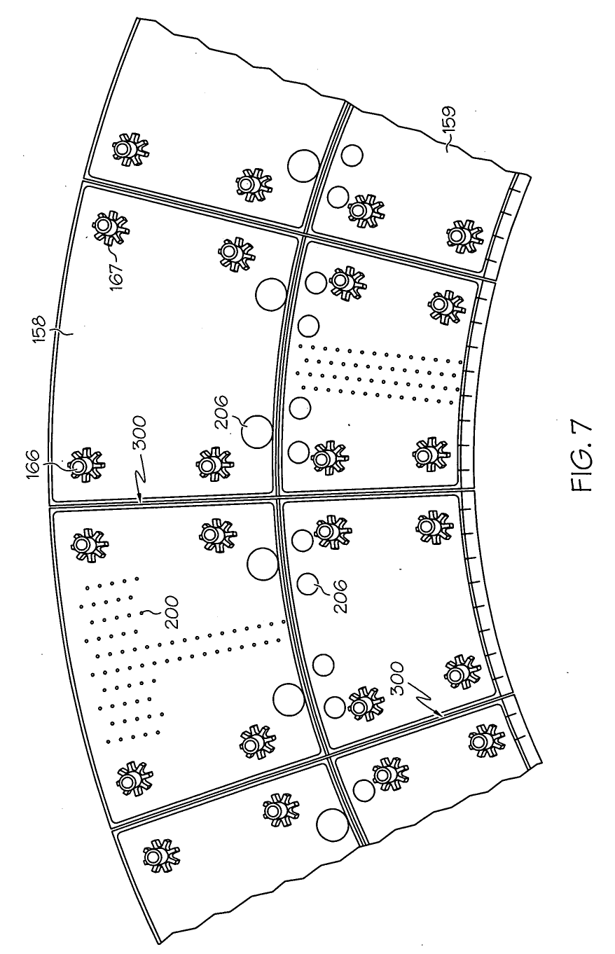

FIG. 7 is an enlarged interior perspective view of a portion of the outer liner 130 illustrating the alignment of the plurality of forward and aft heat shield panels 158, 159. It should be understood that while only a portion of the outer liner 130 is illustrated and described with respect to FIG. 7, the configuration of the forward heat shield panels 158 and the aft heat shield panels 159 are representative of the plurality of forward heat shield panels 160 and the aft heat shield panel 161 that comprise the inner wall 140 of the inner liner 132. In a preferred embodiment, the plurality of forward heat shield panels 158 and the plurality of aft heat shield panels 159 are configured in a circumferentially aligned relationship and form a plurality of aligned gaps 300 there between. The plurality of gaps 300 allow for thermal expansion of the plurality of forward heat shield panels 158 and the plurality of aft heat shield panels 159.

Referring again to FIGS. 4 and 5, an impingement-effusion cooling scheme is used to control the temperature of the metal material that forms the annular combustor 118 of FIG. 2. To this effect, a plurality of effusion holes 202 are formed penetrating through the inner wall 136, and more particularly each of the plurality of forward heat shield panels 158 and each of the plurality of aft heat shield panels 159. As best illustrated in FIG. 4, a plurality of impingement holes 204 are formed penetrating through the outer wall 134. In addition, a plurality of aligned dilution holes 206 (also see FIG. 4) are formed penetrating through the outer wall 134 and the inner wall 136, and more particularly, through each of the plurality of forward heat shield panels 158 and each of the plurality of aft heat shield panels 159. Each of the plurality of dilution holes 206 includes a brazed insert 208 extending between the outer wall 134 and inner wall 136, and into the combustion chamber 126 to permit the flow of air therethrough. In an alternate embodiment, each of the plurality of dilution holes 206 may include an insert for the purpose of directing air through the dilution holes 206 that is press-fit, tack welded, or affixed by some similar means to the outer wall 134 and the inner wall 136.

During cooling, a cooling air flow 210 enters through the plurality of impingement holes 204 and impinges upon a cool side surface 212 of the inner wall 136, and more particularly, a cool side of each of plurality of forward heat shield panels 158 and each of the plurality of aft heat shield panels 159. The cooling air flow 210 then flows through the plurality of effusion holes 202 formed in the inner wall 136, and more particularly through each of the plurality of forward heat shield panels 158 and each of the plurality of aft heat shield panels 159, to form the cooling air film 214 on a hot side surface 216 of the inner wall 136, or the plurality of forward heat shield panels 158 and the plurality of aft heat shield panels 159. In addition, cooling air flow 210 flows through the plurality of controlled openings 200 formed in the aft rails 180 and 192 and aids in augmenting the cooling air film 214. The plurality of dilution holes 206, provide for the flow of a coolant, such as air, through the outer wall 134 and inner wall 136, and into the combustion chamber 126. The impingement cooling process with its higher heat transfer capability in conjunction with the film of cooling air 214 formed due to effusion cooling on the plurality of forward heat shield panels 158 and the plurality of aft heat shield panels 159 results in significant reduction in metal temperatures. In addition, each of the plurality of forward heat shield panels 158, 160 and each of the plurality of aft heat shield panels 159, 161 are formed as discrete components and therefore do not suffer from hoop stress effects experiences in prior art combustor wall configurations.

Accordingly, disclosed is a dual wall structure for a combustor of a turbine engine that provides for cooling of the combustor and accordingly the reduction of emissions. The disclosed method includes a plurality of forward heat shield panels and a plurality of aft heat shield panels that in combination extend substantially the longitudinal length of the combustion chamber, with each heat shield panel including two side rails, a forward rail, and an aft rail including a plurality of controlled openings, that when coupled to an outer wall form a sealed cavity with the outer wall.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

I claim:

1. A dual wall structure for a combustor of a gas turbine engine comprising:
a combustor dome;
an outer liner coupled to said combustor dome; and
an inner liner coupled to said combustor dome and spaced a distance from said outer liner, wherein each of said outer liner and said inner liner comprise:
an outer wall;
an inner wall coupled to the outer wall and separated from the outer wall by a finite distance, the inner wall further comprising:
a plurality of forward heat shield panels, each having a hot side and a cold side, the cold side including a plurality of side rails, a forward rail and an aft rail that when coupled to the outer wall define a cavity there between, a plurality of cavities formed by the plurality of forward heat shield panels; and
a plurality of aft heat shield panels, each having a hot side and a cold side, the cold side including a plurality of side rails, a forward rail and an aft rail that when coupled to the outer wall define a cavity there between, a plurality of cavities formed by the plurality of aft heat shield panels; and
a plurality of threaded studs extending substantially perpendicular from a surface of the cold side of each of the plurality of forward heat shield panels and the plurality of aft heat shield panels, each of the plurality of threaded studs comprising a threaded cylindrical component coupled to a platform,
wherein the aft rail of each of the plurality of forward heat shield panels and the plurality of aft heat shield panels includes a plurality of controlled openings formed therein providing fluidic communication between each of the plurality of cavities and the surface of the hot sides of each of the plurality of forward heat shield panels and the plurality of aft heat shield panels;
wherein a longitudinal length of the combustor is spanned by a single forward heat shield panel of the plurality of forward heat shield panels and by a single aft heat shield panel of the plurality of aft heat shield panels; and
wherein each of the plurality of forward heat shield panels and the plurality of aft heat shield panels includes a plurality of effusion holes for allowing the coolant to flow from the cold side to the hot side and form a cooling film on the surface of the hot side.

2. A dual wall structure for a combustor as claimed in claim 1, wherein each of the plurality of threaded studs extends through an opening formed in the outer wall, thereby providing a means for coupling of each of the plurality of forward heat shield panels and the plurality of aft heat shield panels to the outer wall.

3. A dual wall structure for a combustor as claimed in claim 2, wherein each of the plurality of forward heat shield panels and the plurality of aft heat shield panels comprises four spaced threaded studs.

4. A dual wall structure for a combustor as claimed in claim 2, wherein each of the plurality of threaded cylindrical components is coupled to a substantially star-shaped platform.

5. A dual wall structure for a combustor as claimed in claim 1, wherein each of the plurality of controlled openings is formed as a slot in the aft rail, extending perpendicular from a surface of the cold side of each of the plurality of forward heat shield panels and the plurality of aft heat shield panels.

6. A dual wall structure for a combustor as claimed in claim 1, wherein the outer wall includes a plurality of impingement holes formed therein for allowing a coolant to flow therethrough.

7. A dual wall structure for a combustor as claimed in claim 1, further including a plurality of vertically aligned dilution holes formed in the outer wall and each of the plurality of forward heat shield panels and the plurality of aft heat shield panels.

8. A dual wall structure for a combustor as claimed in claim 7, wherein each of the plurality of vertically aligned dilution holes includes a brazed insert.

9. A dual wall structure for a combustor of a gas turbine engine comprising:
a combustor dome;
an outer liner coupled to said combustor dome; and
an inner liner coupled to said combustor dome and spaced a distance from said outer liner, wherein each of said outer liner and said inner liner comprise:
an outer wall including a plurality of impingement holes formed therein for allowing a coolant to flow therethrough; and
an inner wall coupled to the outer wall, the inner wall comprising a plurality of forward heat shield panels and a plurality of aft heat shield panels, each having a hot side and a cold side,
each of the plurality of forward heat shield panels and the plurality of aft heat shield panels further comprising a plurality of side rails, a forward rail, and an aft rail extending substantially perpendicular from a surface of the cold side, the plurality of side rails, the forward rail and the aft rail defining a cavity between the inner wall and the outer wall when coupled together, a plurality of cavities formed by the plurality of forward heat shield panels and said plurality of aft heat shield panels;
each of the plurality of forward heat shield panels and the plurality of aft heat shield panels further comprising a plurality of threaded studs extending substantially perpendicular from the surface of the cold side and through a plurality of holes defined in the outer wall, each of the plurality of threaded studs comprising a threaded cylindrical component coupled to a platform and providing a means for coupling each of the plurality of forward heat shield panels and the plurality of aft heat shield panels to the outer wall;
wherein the aft rail of each of the plurality of forward heat shield panels and the plurality of aft heat shield panels includes a plurality of controlled openings formed therein, the plurality of controlled openings providing fluidic communication between each of the plurality of cavities and the surface of the hot side of each of the plurality of forward heat shield panels and the plurality of aft heat shield panels; and
wherein a longitudinal length of the combustor is spanned by a single forward heat shield panel of the plurality of forward heat shield panels and by a single aft heat shield panel of the plurality of aft heat shield panels.

10. A dual wall structure for a combustor as claimed in claim 9, wherein each of the plurality of forward heat shield panels and the plurality of aft heat shield panels includes a plurality of effusion holes for allowing the coolant to flow from the cold side to the hot side and form a cooling film on the surface of the hot side.

11. A dual wall structure for a combustor as claimed in claim 9, wherein each of the plurality of forward heat shield panels and the plurality of aft heat shield panels comprises four spaced threaded studs.

12. A dual wall structure for a combustor as claimed in claim 9, wherein the threaded cylindrical component is coupled to a platform adjacent the surface of the cold side of each of the plurality of forward heat shield panels and the plurality of aft heat shield panels and configured to provide mechanical support.

13. A dual wall structure for a combustor as claimed in claim 9, wherein the plurality of forward heat shield panels and the plurality of aft heat shield panels are coupled to the outer wall in a circumferentially aligned configuration and form a plurality of aligned gaps between each of the plurality of forward heat shield panels and the plurality of aft heat shield panels.

14. A dual wall structure for a combustor as claimed in claim 9, further including a plurality of vertically aligned dilution holes formed in the outer wall and each of the plurality of forward heat shield panels and the plurality of aft heat shield panels.

15. A dual wall structure for a combustor as claimed in claim 14, wherein each of the plurality of vertically aligned dilution holes includes one of a brazed insert, a tap-fit insert, or a tack-welded insert.

16. A combustor for a gas turbine engine comprising:
an outer liner and an inner liner coupled to a combustor dome, wherein the inner liner and the outer liner define a combustion chamber there between;
an outer wall comprising a portion of each of the outer liner and the inner liner;
a plurality of forward heat shield panels and a plurality of aft heat shield panels comprising a portion of each the outer liner and the inner liner; and
a plurality of threaded studs extending substantially perpendicular from a surface of each of the plurality of forward heat shield panels and the plurality of aft heat shield panels, each of the plurality of threaded studs comprising a threaded cylindrical component coupled to a platform with brazing,
each of the plurality of forward heat shield panels and the plurality of aft heat shield panels having a hot side and a cold side, the cold side having a plurality of side rails, a forward rail and an aft rail that when coupled to the outer wall of each of the outer liner and the inner liner define a cavity between each of the plurality of forward heat shield panels and the plurality of aft heat shield panels and the outer wall, a plurality of cavities formed by the plurality of forward heat shield panels and the plurality of aft heat shield panels,
wherein the plurality of forward heat shield panels and the plurality of aft heat shield panels are coupled to the outer wall in a circumferentially aligned configuration and form a plurality of aligned gaps between each of the plurality of forward heat shield panels and the plurality of aft heat shield panels,
wherein each of the plurality of forward heat shield panels and the plurality of aft heat shield panels includes a plurality of effusion holes for allowing a coolant to flow from the cold side to the hot side and form a cooling film on a surface of the hot side.

17. A combustor for a gas turbine engine as claimed in claim 16, wherein each of the plurality of threaded studs extends substantially perpendicular from the surface of the cold side of each of the plurality of forward heat shield panels and the plurality of aft heat shield panels.

18. A combustor for a gas turbine engine as claimed in claim 17, wherein the threaded cylindrical component of each of the plurality of threaded studs extends through an opening formed in the outer wall of each of the inner liner and the outer liner, thereby providing coupling of each of the plurality of forward heat shield panels and the plurality of aft heat shield panels to the outer wall.

19. A combustor for a gas turbine engine as claimed in claim 16, wherein the aft rail of each of the plurality of forward heat shield panels and the plurality of aft heat shield panels includes a plurality of controlled openings formed therein, the plurality of controlled openings providing fluidic communication between each of the plurality of cavities and the surface of the hot side of each of the plurality of forward heat shield panels and the plurality of aft heat shield panels.

20. A combustor for a gas turbine engine as claimed in claim 16, wherein the outer wall includes a plurality of impingement holes formed therein.
